(19) United States
(12) Patent Application Publication
(10) Pub. No.: US 2004/0183359 A1
(43) Pub. Date: Sep. 23, 2004

(54) Wheel spinner assembly independently rotatable relative to a corresponding wheel

(76) Inventor: David Fowlkes, Norristown, PA (US)

Correspondence Address: Blank Rome LLP, 600 New Hampshire Avenue NW, Washington, DC, 20037, US

(21) Appl. No.: 10/391,512

(22) Filed: Mar. 18, 2003

(51) Int. Cl. B60B 7/04

(52) U.S. Cl. 301/37.101; 301/37.25

(57) ABSTRACT

A wheel spinner assembly mountable onto a corresponding wheel of a vehicle is provided. The assembly includes a spinner hub supportable by the wheel. The spinner hub supports a spindle and a bearing assembly. An ornamental spinner is secured to the bearing assembly to permit the spinner to rotate relative to the vehicle wheel. An assembly nut serves to secure the ornamental spinner to the spindle for ease of removal.

### RELATED APPLICATION DATA

This application claims benefit of co-pending application Ser. No. 09/923,918 filed on Aug. 7, 2001 the contents of which are incorporated herein by reference. Application Ser. No. 09/923,918 claims priority from provisional patent application serial No. 60/224,501 filed Aug. 11, 2000; the contents of this provisional application are also incorporated herein.

### BACKGROUND OF THE INVENTION

The present invention is generally related to wheel spinners and, more particularly, to a wheel spinner assembly that allows independent rotation of a wheel spinner relative to wheel rotational speed.

Vehicle wheels held in place by decorative nuts, sometimes referred to as spinner nuts, are a well-known and familiar sight on vehicles and also in racing and competition vehicles. Further, a number of sports cars, imported and domestic, have been provided with wire wheels or light-alloy wheels, which are mounted on the vehicle by such decorative nuts. In known wheel assemblies, the wheel and decorative nut have a direct mechanical coupling to one another and consequently the decorative nut rotates at the same rotational speed as the wheel, e.g., same revolutions per minute, (RPM). Thus, as the vehicle moves, the wheel and the decorative nut may be perceived by observers outside the vehicle as a rather pleasant blur.

Other known wheel assemblies have used bearing means to fully decouple wheel rotation from a stationary wheel cover, such as may be desirable when that cover carries advertisement displays or other information that, in order to be legible to an observer, needs to be stationary when the vehicle is in motion. Thus, the foregoing known wheel assemblies are designed either to rotate at full wheel speed, or, conversely, to fully suppress rotation as the wheel rotates. However, it is believed that no technique has been provided that takes advantage of aesthetically pleasant visual effects that may occur if the spinner were to rotate at a different speed relative to the wheel speed.

In view of the foregoing, it would be desirable to provide a wheel spinner that rotates at a different rotational speed than the speed of the wheel so as to provide an aesthetically pleasing view to the observer. For example, if the rotational speed of the wheel spinner is less relative to the rotational speed of the wheel (or some multiple of it), then this may result in giving the illusion to the observer that the vehicle is “hovering”, as the wheel/wheel spinner combination gives the appearance of standing still to that observer. Further, visually pleasant effects may be achieved if the spinner continues to spin for an extended period of time after the vehicle comes to a stop.

### SUMMARY OF THE INVENTION

Generally, the present invention fulfills the foregoing needs by providing in one aspect thereof, a wheel spinner assembly mountable onto a corresponding wheel of a vehicle. The assembly includes a wheel mount supportable by the wheel. A spinner mount is connected to the wheel mount. A bearing assembly is supported by the spinner mount. A spinner is supported by the bearing assembly, wherein the bearing assembly allows the spinner to rotate independently relative to the corresponding wheel as the vehicle is in motion.

The present invention further fulfills the foregoing needs by providing in another aspect thereof, a wheel spinner assembly to be mounted onto a corresponding wheel of a vehicle. The wheel spinner assembly includes a spinner and a bearing assembly configured to provide independent rotational motion between the spinner and the wheel as the vehicle is in motion, and wherein the angular moment of inertia of the spinner is chosen to facilitate continued rotation of the spinner as the vehicle comes to a stop.

In yet another aspect of the present invention, the wheel spinner assembly includes a spinner, and a bearing assembly configured to provide independent rotational motion between the spinner and the wheel, and wherein the spinner is rotatable at a speed lesser than that of the wheel speed. The lesser speed generally results in an observer perceiving no apparent, or slower, rotational motion of the wheel as the vehicle is in motion.

### DESCRIPTION OF THE DRAWINGS

FIG. 1 illustrates an isometric view of an exemplary wheel spinner assembly in accordance with one aspect of the present invention, and wherein the wheel spinner assembly is illustrated in combination with a wheel of a vehicle.

FIG. 2 illustrates an exploded view of the wheel spinner assembly of FIG. 1.

FIG. 3 illustrates an elevational front view of the wheel spinner assembly of FIG. 1.

FIG. 4 is a cross sectional view of an alternative embodiment of the wheel spinner of the present invention.

FIG. 5 is a cross sectional view of an alternative embodiment of the wheel spinner of the present invention.

FIG. 6 is a cross sectional view of an alternative embodiment of the wheel spinner of the present invention.

FIG. 7 is a cross sectional view of an alternative embodiment of the wheel spinner of the present invention.

FIG. 8 is an exploded view of an alternative embodiment of the present invention.

FIG. 9 is a partial sectional view of the alternative embodiment of the present invention.

FIG. 10 is an exploded view of the wheel spinner assembly of the alternative embodiment being installed upon a vehicle.

Before any embodiment of the invention is explained in detail, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE PREFERRED EMBODIMENT

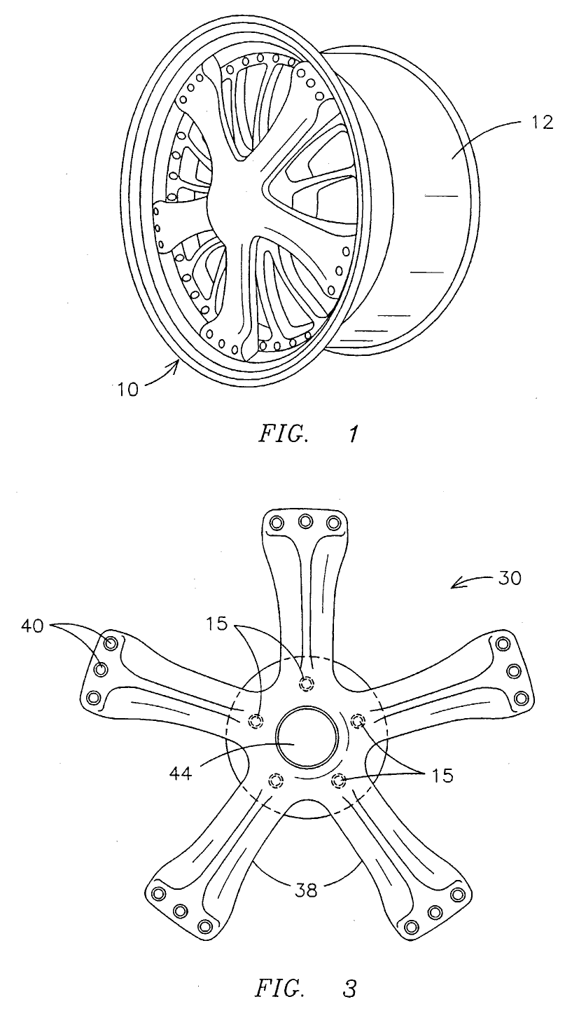

FIG. 1 illustrates an exemplary spinner assembly 10 in accordance with one aspect of the present invention. Spinner assembly 10 is mountable, as described in further detail below, onto a corresponding wheel 12 of a vehicle. It will be appreciated that the present invention is not limited to self-propelled vehicles since hauling transportation equipment, such as semi-trailers, boat-carrying trailers, etc., may equally benefit from the wheel spinner embodying the present invention.

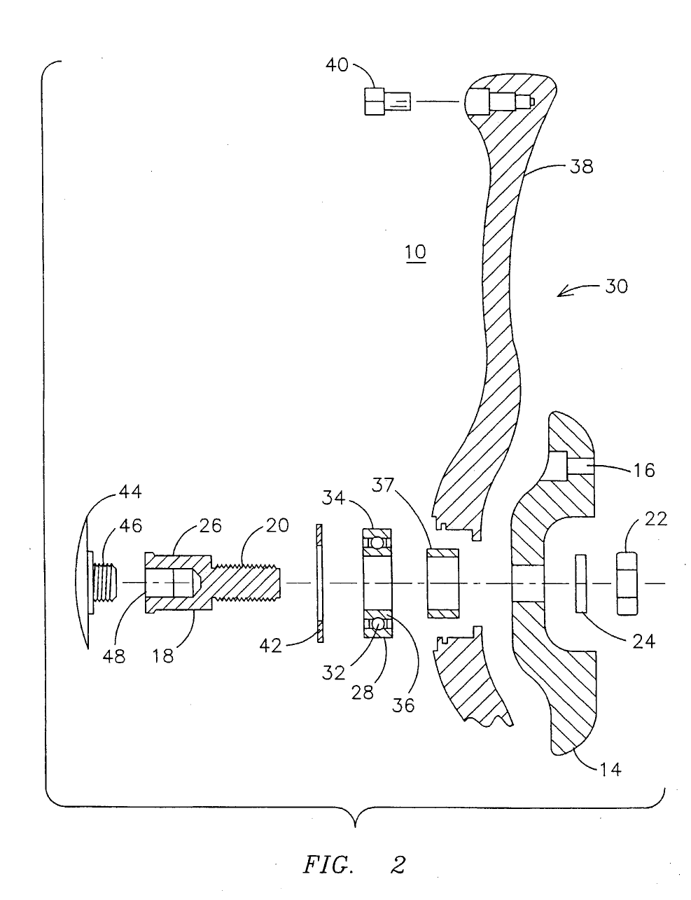

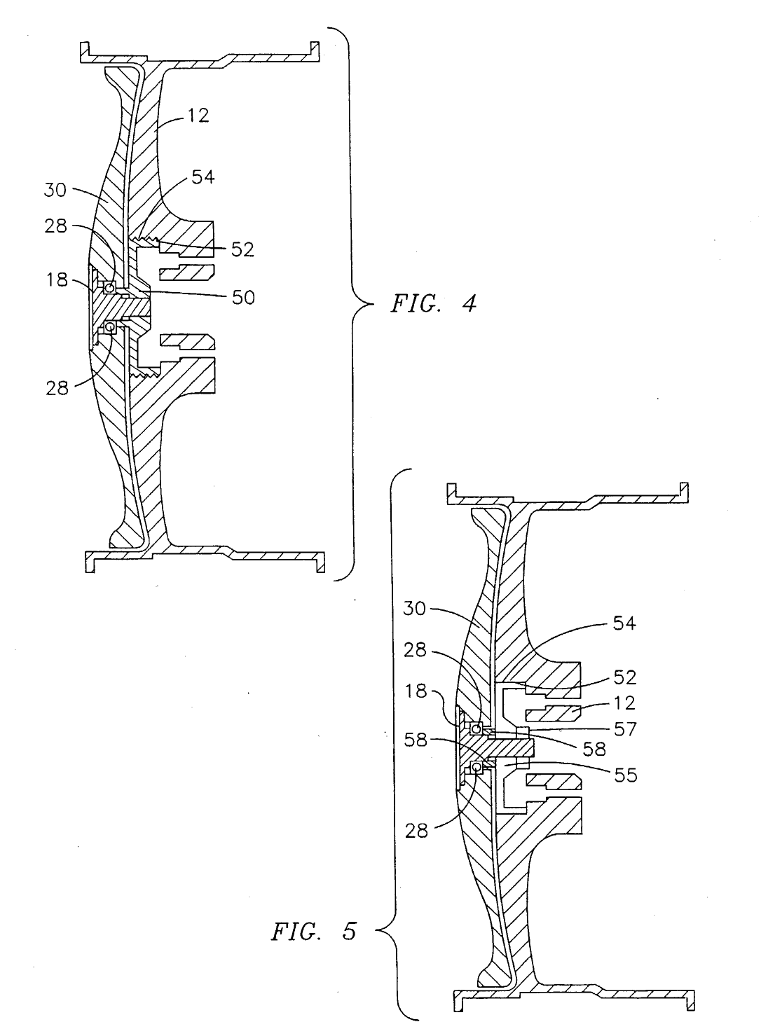

As shown in FIG. 2, spinner assembly 10 comprises a wheel mount 14 directly affixed to a respective wheel of the vehicle, e.g., wheel 12 (FIG. 1), by suitable fastening means, such as a plurality of bolts 15 (FIG. 3) which respectively extend through a plurality of corresponding bolt passageways in wheel mount 14, e.g., passageway 16, to be received by corresponding openings (not shown) constructed in the wheel of the vehicle. In one exemplary embodiment, bolts 15 are distinct from any bolts that may be commonly used for affixing the wheel to the vehicle.

A spinner mount, or spindle, 18 is fixedly connected to wheel mount 14 by suitable connecting means, such as a threaded section 20 of spinner mount 18, configured to receive a corresponding nut 22 and washer 24. The spinner mount further includes a section 26 configured to receive a bearing or bushing assembly 28 that permits independent rotational motion between the spinner mount 18 and a spinner 30. That is, bearing assembly 28 allows spinner 30 to rotate at a different speed relative to the wheel speed.

By way of example, bearing assembly 28 may comprise a ball bearing assembly including a plurality of balls 32 confined between outer and inner rings 34 and 36 respectively. A bearing collar 37 may be provided to provide radial support to the inner ring of the bearing assembly. In one exemplary embodiment, bearing assembly 28 is press fitted onto the spinner mount 18. A retainer ring 42 may be used to provide axial support to bearing assembly 28. It will be appreciated that other types of bearings assemblies may be utilized to provide a desired degree of rotational motion between the spinner mount 18 and spinner 30, depending on various factors, such as vehicle wheel cruising speed, degree of surface irregularities on roads traveled by the vehicle, typical environmental conditions where the vehicle will be operated, etc.

As better seen in FIG. 3, spinner 30 comprises a plurality of radially extending spokes 38 supported by the bearing assembly 28. In one exemplary embodiment, the geometric design of the spinner 30 may be configured so that the mass of the spinner 30 is principally distributed about the outer tip or distal end of the spokes so as to have a larger angular moment of inertia relative to a spinner configuration whose mass is more closely distributed relative to the center of the spinner. In another exemplary embodiment, the angular moment of inertia of the spinner may be increased by placing weights, such as one or more screws 40, near the outer tip of the spokes. In one exemplary embodiment, the spinner 30 is made up of aluminum material. It will be appreciated that the present invention is not limited to any specific material being that any other generally corrosive-resistant, relatively light weight, high strength metal and/or alloy may be readily used for the spinner. An optional cap 44 may be received by spinner mount 18. For example, cap 44 may display a logo and include a threaded extension 46 that may be received by a corresponding receptacle 48 in spinner mount 18. Thus, when wheel 12 stops, the cap 44 also comes to a stop, thereby making any logos on the cap 44 readable.

### Alternative Embodiment: FIG. 4

With respect to FIG. 4, an embodiment is shown that illustrates how an alternative wheel mount 50 may be connected to the wheel 12. The wheel mount 50 has a threaded section 52 extending along an outer perimeter surface of the wheel mount 50. The wheel 12 has a threaded section 54 which mates with the threaded section 52 on the wheel mount 50 for securing the wheel mount 50 to the wheel 12. The spinner assembly, spinner mount 18, spinner 30 and bearing 28 are coupled to wheel 12. Specifically, spinner mount 18 is threadably received within wheel mount 50. In this regard, both spinner mount 18 and wheel mount 50 are provided with mating threaded portions. Additionally, a bearing assembly is employed in rotatably interconnecting spinner 30 and spinner mount 18. This embodiment reduces the number of parts required to install the spinner assembly by eliminating the need for a plurality of bolts 15 for mounting the wheel mount 50 to the wheel 12.

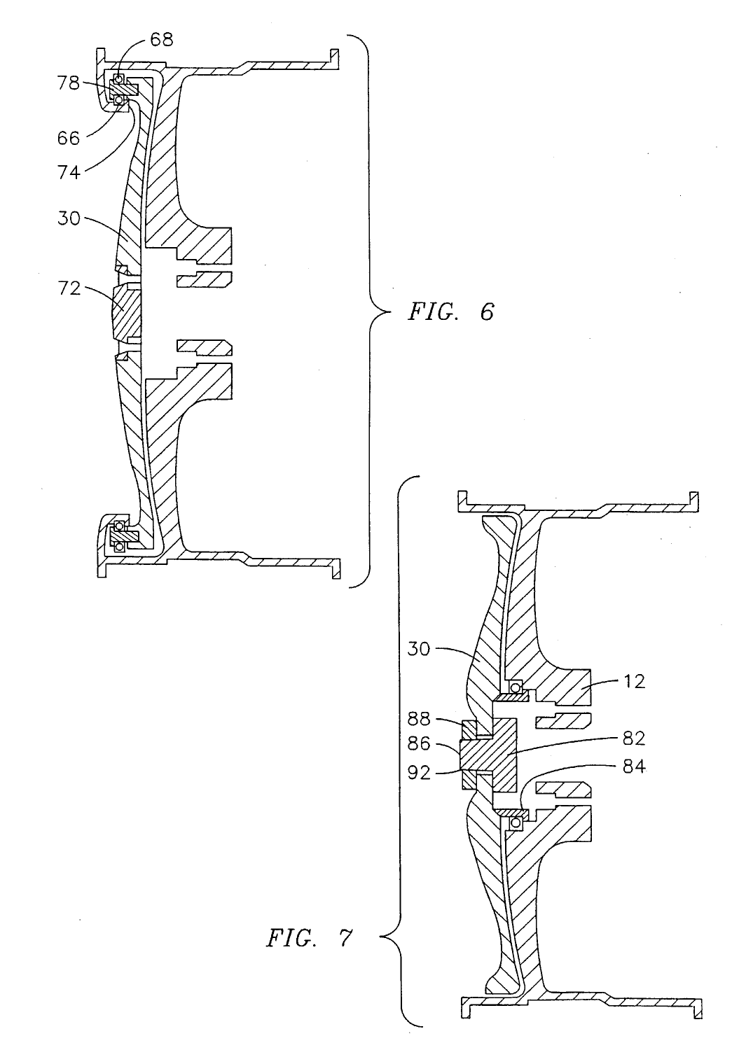

### Alternative Embodiment: FIG. 5

Assembly parts can further by reduced as shown in FIG. 5. FIG. 5 illustrates yet another alternative embodiment. This embodiment employs an alternative wheel mount 55. Similar to the embodiment shown in FIG. 4, the wheel mount 55 has a threaded section 52 extending along an outer perimeter surface of the wheel mount 55. The wheel has a threaded section 54 for mating relationship with the threaded section 52 on the wheel mount 55 for securing the wheel mount 55 on the wheel 12. In addition the wheel mount 55 has two spacers 58 integrally formed thereon. These spacer properly orient wheel mount 55 with respect to wheel 12 and bearing 28. Wheel mount 55 is not internally threaded. As such, a nut 57 is threaded onto the end of spinner mount 18, to thereby lock the wheel mount 55 to spinner mount 18.

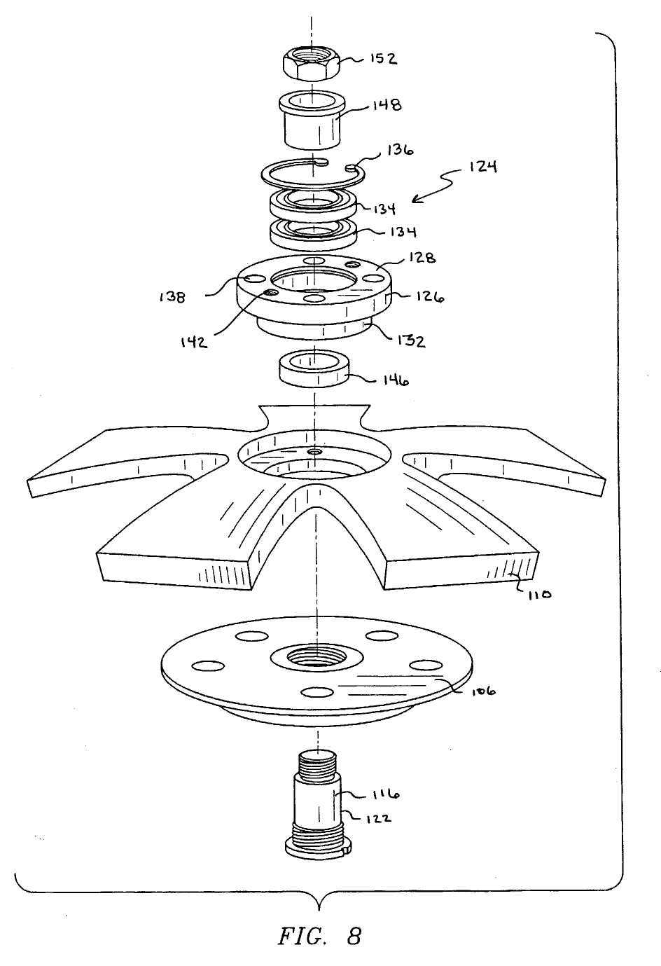

### Alternative Embodiment: FIG. 6

With respect to FIG. 6, wheel 12 is adapted with a track 66. The track 66 guides radial bearings 68 that are connected to the ends of the spokes of spinner 30. The spinner 30 includes a plurality of spokes extending radially from a spinner center 72. The spinner center 72 is mounted to a first end of the spinner arms by fasteners. For example, bolts can be used to fasten the spinner center 72 to the spinner arms, each of which has corresponding threaded holes for receiving the bolts. The wheel 12 includes an upwardly disposed lip 74 adjacent a second end of the spokes distal the spinner center 72. A track 66 extends circumferentially along the lip 74. A bearing assembly 68 is connected to the distal end of each spoke, and fits within the track 66. The bearing assembly 68 is connected to the spoke by a fastener 78 that permits rotational motion on the fastener 78 within the track 66. For example a bolt having a threaded section secures the bearing assembly 68 on the spoke, while permitting rotational motion thereon. In this manner, when the wheel 12 rotates, the bearing assemblies 68 rotate on the bolt and travel within the track 66 facilitating rotation of the spinner assembly independent of the wheel 12.

### Alternative Embodiment: FIG. 7

FIG. 7 illustrates yet another embodiment of the present invention. This embodiment utilizes an alternative wheel mount construction 82. This wheel mount 82 includes an integral spindle 84. A bearing assembly is provided intermediate the wheel mount 82 and wheel 12. The bearing assembly permits the entire wheel mount 82 to rotate independently of the wheel 12. The wheel mount 82 further includes a threaded hub 86 to which the spinner 30 is connected. A spinner retainer nut 88 is adapted to be secured to the hub 86 and to positively secure the spinner 30, preventing it from rotating relative to the wheel mount 82. This retainer nut 88 includes an outer surface 92 which can carry indicia or logos. As can be appreciated, this embodiment allows the spinner 30 to be easily replaced with other designs or styles. That is, replacing the spinner 30 merely involves removing the threaded retaining nut 88.

The operation of each of the embodiments of the present invention is next described. In operation, due to centrifugal force, residual friction in the bearing assembly or both, the spinner can rotate independently relative to the rotation of the wheel. For example, the spinner may rotate at a slower RPM relative to the wheel speed. By way of example and not of limitation, the spinner rotation may range from about 10% to about 90% of the wheel rotation. When the vehicle comes to a full stop, the spinner may continue to revolve while gradually decreasing its RPM until coming to a full stop. When the vehicle starts to move forward, the spinner will gradually increase its RPM until a maximum spinner RPM is reached. As suggested above, in one exemplary embodiment the maximum spinner speed may be chosen relative to the wheel speed to give the illusion to the observer that the wheel/wheel spinner is standing still and that the vehicle is hovering.

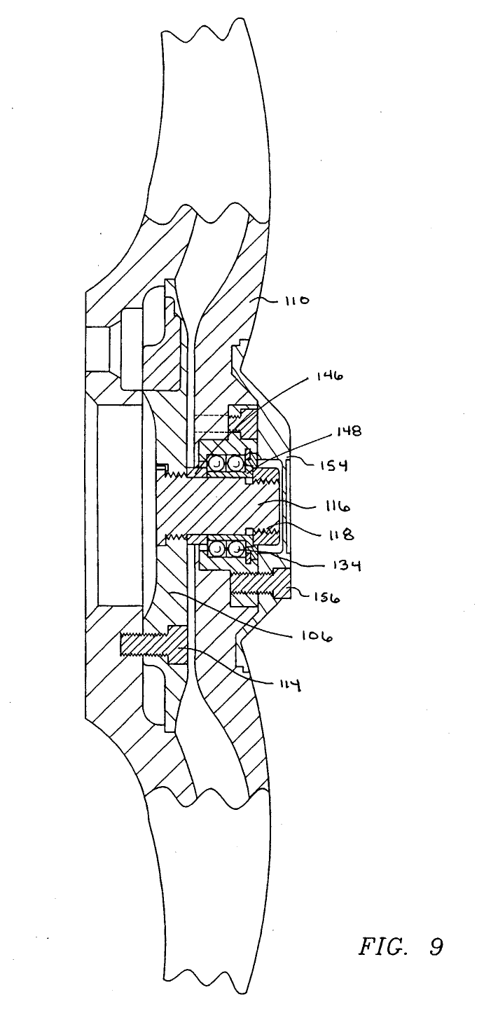

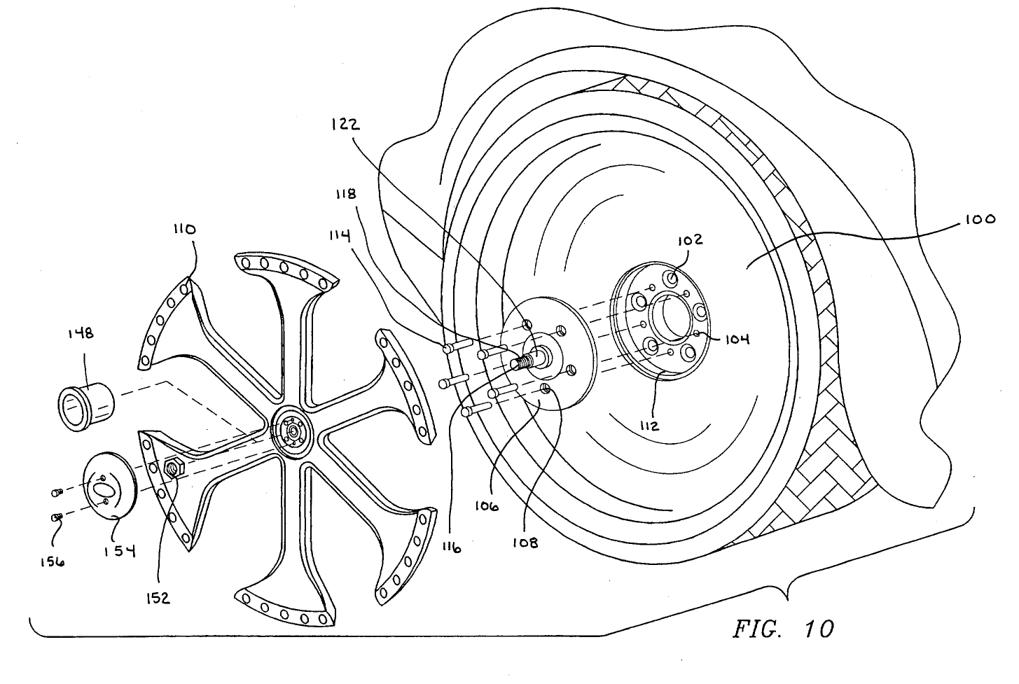

### Alternative Embodiment FIGS. 8-10

Yet another alternative embodiment is illustrated in FIGS. 8-10. This embodiment is a quick-change embodiment because it enables the user to easily remove and/or replace the spinner assembly. Removal and replacement speeds are increased by allowing the spinner to be accessed without the need for taking apart the associated mounting assembly. Moreover, by way of an end cap, this quick-change assembly does not sacrifice the security of the spinner or wheel. These and other benefits are realized by repositioning the assembly components described in the embodiment of FIG. 2. Namely, the assembly of FIG. 2 is reoriented such that the assembly nut is accessible to a user without the need for removing any other components. The alternative embodiment of FIGS. 8-10 shares many of the same components described hereinabove in conjunction with the other embodiments. However, these components are again described hereinafter for sake of clarity.

With reference now to FIG. 8, an exploded illustration of the quick-change embodiment is depicted. Additionally, FIG. 10 illustrates the manner in which this embodiment is secured to a vehicle wheel. The assembly includes the vehicle wheel 100, which is specially modified to include a first and second set of apertures (102 and 104, respectively). The first set of apertures 102 receives a series of studs from a conventional brake hub. As is known in the art, the brake hub is interconnected to the vehicle axle.

The vehicle wheel 100 is secured to the brake hub via the studs; thereafter, lug nuts are secured over the studs. The user should ensure that the lug nuts are tightened sufficiently to securely retain the vehicle wheel upon the brake hub. Preferably, the lug nuts are sequentially tightened in a crisscross or star pattern to ensure a proper fitting.

With continuing reference to FIG. 10, the spinner hub 106 is depicted. This spinner hub 106 as a peripheral extent with a series of apertures formed therein 108. The number and positioning of these apertures corresponds to the second set of apertures 104 within the vehicle wheel 100. Preferably, the spinner hub 106 is dimensioned to be received within a central recess 112 within the vehicle wheel 100 such that when the hub 106 is properly mounted, it is flush with the surrounding vehicle wheel 100. The spinner hub 106 is secured by a series of mounting bolts 114. These mounting bolts 114 are positioned through the apertures 108 within the peripheral extent of the spinner hub 106 and are threadably secured within the second set of apertures 104 of the vehicle wheel 100. In the preferred embodiment, the second set of apertures 104 are tapped, such that the mounting bolts need only be threaded within the vehicle wheel 100 to properly secure the spinner hub 106. Thus, no nuts or other fasteners are needed. As is described more fully hereinafter, the spinner hub 106 functions to support the ornamental spinner 110 of the present invention. The hub 106 accepts the forces generated by the spinning of the spinner 110. As such, the vehicle wheel 100 does not directly receive the centripetal forces generated by the spinner 110.

With reference now to FIG. 8, the spindle 116 of the mounting assembly is described. The spindle 116 includes a proximal end that is mounted to the spinner hub 106. The interconnection between the proximal end of the spindle 116 and the spinner hub 106 can be a threaded interconnection. Other forms of spindle-hub interconnections are also in the scope of the present invention. For example, it is within the scope of the present invention to form the spindle and spinner hub as an integral unit. The spindle 116 further includes a threaded distal end 118. The spindle further includes an intermediate extent 122 between the proximal and distal ends. This intermediate extent of the spindle is adapted to receive a bearing assembly 124.

The bearing assembly 124 of the quick-change embodiment includes a variety of components. The main component is the bearing housing 126. This housing includes a first enlarged extent 128 and a second narrowed extent 132. The bearing housing 126 receives one or more bearings 134 as well as a locking washer 136 with the locking washer 136 securing the bearings 134 within the bearing housing 126. The bearing housing 126 further includes a first and second set of apertures (138 and 142, respectively). The first set of apertures 138 secures the housing 126, and its internal components, to the spinner 110. More specifically, the bearing housing 126 is positioned within a central recess within the spinner 110. Thereafter, bolts are used to affix the bearing housing 126. These bolts are positioned through the first set of apertures 138 within bearing housing 126 and received within corresponding apertures within the spinner 110.

With the bearing assembly 124 secured within the spinner 110, the bearing assembly 124 and spinner 110 can then be positioned over the spindle 116. In this regard, the mounting assembly further includes a spacer ring 146 and sleeve 148. Specifically, a spacer ring 146 is positioned over the spindle 116 prior to the positioning of the spinner 110 and bearing assembly 124 to ensure that the spinner 110 is spaced a sufficient distance above the surface of the spinner hub 106. Thereafter, the ornamental spinner 110 with the secured bearing assembly 124 is slid over the spindle 116. That is, the bearing assembly 124 is positioned over the intermediate extent 122 of the spindle 116. Next, the bearing sleeve 148 is inserted between the bearings 134 of the bearing assembly 124 and the intermediate extent 122 of the spindle 116. This sleeve 148 ensures a proper fit between the spindle 116 and bearing 134 and also serves to alleviate any frictional forces between the bearing 134 and spindle 116. With this arrangement, the spinner 110 can rotate relative to both the vehicle wheel 100 and the spinner hub 106.

The entire assembly is finally secured by way of an assembly nut 152 that is threadably secured to the distal end 118 of the spindle 116. As such, a user need only remove the assembly nut 152 to slide the bearing assembly 124 and spinner 110 on and off of the spindle 116.

To prevent unauthorized removal of the spinner, an end cap 154 is included. This end cap 154, which is depicted in FIG. 10, can be positioned over the assembly nut 152. Thereafter, two locking caps 156 are employed in securing the end cap 154. Specifically, the locking caps 156 are positioned through the end cap 154 and are received within the second set of apertures of the bearing housing 126. The locking caps 156 have uniquely shaped recesses, such that they cannot be secured or removed absent a specialized Allen wrench.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

What is claimed is:

1. A mounting assembly for a vehicle, the vehicle including a brake hub interconnected to a vehicle axle, the break hub including a series of studs, the mounting assembly comprising:
a vehicle wheel having a first and second set of apertures, the studs secured within the first set of apertures to thereby secure the vehicle wheel to the brake hub;
a spinner hub having a peripheral extent with a series of apertures formed therein;
a series of mounting bolts secured through the apertures of the spinner hub and secured within the second set of apertures of the wheel to thereby secure the spinner hub to the vehicle wheel;
a spindle having a proximal end mounted to the spinner hub and a threaded distal end, a bearing assembly mounted upon the spindle intermediate the proximal and distal ends;
an ornamental spinner secured to the bearing assembly to permit the ornamental spinner to rotate relative to the spinner hub and vehicle wheel;
an assembly nut threadably secured to the threaded distal end of the spindle such that a user can easily replace the spinner by removing the assembly nut and sliding the spinner and bearing assembly off of the spindle and wherein forces generated by rotation of the spinner are encountered by the spinner hub and not the vehicle wheel;
an end cap positioned over the assembly nut, one or more locking bolts securing the end cap to the bearing assembly, the locking bolts preventing unauthorized removal of the end cap.

2. A mounting assembly for securing an ornamental spinner to a vehicle wheel, the mounting assembly comprising:
a spinner hub mounted to the vehicle wheel;
an ornamental spinner rotatably secured to the spinner hub to permit the ornamental spinner to rotate relative to the vehicle wheel;
an assembly nut serving to secure the ornamental spinner to the spinner hub such that a user can easily replace the spinner by removing the assembly nut.

3. The mounting assembly as described in claim 2 wherein the spinner hub includes a centrally positioned spindle and wherein a bearing assembly is mounted to the spindle and supports the ornamental spinner.

4. The mounting assembly as described in claim 2 wherein the spinner hub is mounted to the vehicle wheel via a series of mounting bolts.

5. The mounting assembly as described in claim 2 wherein an end cap is positioned over the assembly nut, and wherein one or more locking bolts secured the end cap to the mounting assembly, the locking bolts preventing unauthorized removal of the end cap.

6. A spinner assembly for a vehicle comprising:
a vehicle wheel having a first and second set of apertures, a series of studs secured within the first set of apertures to thereby secure the vehicle wheel to a conventional brake hub;
a spinner hub having a peripheral extent with a series of apertures formed therein;
a series of mounting bolts secured through the apertures of the spinner hub and secured within the second set of apertures of the wheel to thereby secure the spinner hub to the vehicle wheel;
a spindle having a proximal end mounted to the spinner hub and a distal end;
an ornamental spinner secured to the spindle to permit the ornamental spinner to rotate relative to the spinner hub and vehicle wheel.

7. The spinner assembly as described in claim 6 further comprising an assembly nut threadably secured to a threaded distal end of the spindle such that a user can easily replace the spinner by removing the assembly nut and sliding the spinner off of the spindle and wherein forces generated by rotation of the spinner are encountered by the spinner hub and not the vehicle wheel.

8. The spinner assembly as described in claim 7 wherein a bearing assembly is positioned between the spindle and spinner.

9. The spinner assembly as described in claim 7 further comprising an end cap positioned over the assembly nut.

10. The spinner assembly as described in claim 9 wherein one or more locking bolts are used to secure the end cap to the bearing assembly, the locking bolts preventing unauthorized removal of the end cap.
